(19) United States
(12) Patent Application Publication
(10) Pub. No.: US 2004/0020322 A1
(43) Pub. Date: Feb. 5, 2004

(54) Brake handle structure for mobility aid

(76) Inventor: Yu-Chi Hsieh, Taoyuan City (TW)

Correspondence Address: BACON & THOMAS, PLLC, 625 SLATERS LANE, FOURTH FLOOR, ALEXANDRIA, VA, 22314

(21) Appl. No.: 10/207,839

(22) Filed: Jul. 31, 2002

(51) Int. Cl. F16C 1/10

(52) U.S. Cl. 74/502.2

(57) ABSTRACT

In an improved brake handle structure for a mobility aid, a control handle is connected to a handlebar of a vehicle body. The control handle has a main body. An upper section of the main body has a transverse through bar hole. The handlebar extends through the bar hole and is then secured. A lateral side of the main body is provided with a brake pull wire hole for extension of a brake wire therethrough, with a plug inserted into a securing groove in a rotary pull lever. The main body is provided with upper and lower cavities for insertion of upper and lower corners of an inner end of the pull lever. A press rod cavity is disposed above the pull wire hole of the main body for insertion of an outer end of a press rod. The inner end of the press rod is connected pivotally in a rod sleeve of the pull lever. A projecting portion is provided near one side of the outer end of the press rod. A notch portion is provided between the projecting portion and the outer end of the press rod. Relative to the main body is an inwardly projecting securing portion, such that when the pull lever rotates about a large angle, the outer end of the press rod moves beyond the press rod cavity to the securing portion to be retained thereby so as to be in a permanent braking state, and when the pull lever is pulled in a reverse direction, a temporary braking state is achieved.

### BACKGROUND OF THE INVENTION

(a) Field of the Invention

The invention relates to an improved brake handle of a mobility aid, particularly to a hand brake structure of a mobility aid or a rehabilitation aid, more particularly to a control mechanism that constitutes permanent braking when pulled to a relatively extent and that constitutes temporary braking when pulled in a reverse direction.

(b) Description of the Prior Art

The aged or the infirm require assistance in walking, and generally use a mobility aid as a means for walking or walking assistance. Mobility aids in the form of a vehicle have to be provided with wheels. Mobility aids, such as walkers, wheelchairs, cannot move too fast; otherwise, they may get out of control. A braking structure for controlling the same is therefore needed. In a conventional braking structure, the brake handle is moved toward the handle, and merely provides a temporary braking function. If the user wants to leave the mobility aid after braking, the mobility aid may start to move instantly, which is not safe for the user of the mobility aid. Therefore, there have been developed hand brake structures for conventional mobility aids to overcome the problem associated with temporary braking. That is, a permanent braking structure is mounted directly near the wheels or disposed on the same handle. In the former case, operation is inconvenient, and the user needs to bend down to secure the structure, which is inconvenient to the user. Improvement is therefore directed to the control structure of the handle so that it has both permanent and temporary braking functions. There are many structures known in the art. However, in these structures, temporary braking is formed in the pulling direction, and permanent braking is formed in the pushing direction. However, these structures are fairly complicated and the functions thereof are not much different. Since such braking structures of mobility aids require economy in time and labor in order to facilitate use by patients, old people, children, and the disabled. In order to provide products that better meet actual needs, the inventor conducts research and development to overcome the problems associated with complicated structure, manufacturing costs and facility.

### SUMMARY OF THE INVENTION

The object of the invention is to provide an improved brake handle for a mobility aid, in which a press rod cavity is formed at an upper end of a handle main body where a brake wire extends therethrough, the press rod being moved by a pull lever. The pull lever has one corner rotating in a corresponding cavity of the main body. The main body has an inwardly projecting securing portion near the cavity. When the pull lever is pulled by hand to rotate a large angle, the outer end of the press rod will move beyond the press rod cavity to the securing portion to be retained thereby so as to constitute permanent braking. When the pull lever is rotated in a reverse direction, temporary braking is achieved.

In order to achieve the above object, the invention includes a control handle connected to a handlebar of a vehicle body. The control handle has a main body. An upper section of the main body has a transverse through bar hole. The handlebar extends through the bar hole and is then secured. A lateral side of the main body is provided with a brake pull wire hole for extension of a brake wire therethrough, with a plug inserted into a securing groove in a rotary pull lever. The main body is provided with upper and lower cavities for insertion of upper and lower corners of an inner end of the pull lever. A press rod cavity is disposed above the pull wire hole of the main body for insertion of an outer end of a press rod. The inner end of the press rod is connected pivotally in a rod sleeve of the pull lever. A projecting portion is provided near one side of the outer end of the press rod. A notch portion is provided between the projecting portion and the outer end of the press rod. Relative to the main body is an inwardly projecting securing portion, such that when the pull lever rotates about a large angle, the outer end of the press rod moves beyond the press rod cavity to the securing portion to be retained thereby so as to be in a permanent braking state, and when the pull lever is pulled in a reverse direction, a temporary braking state is achieved.

### BRIEF DESCRIPTION OF TIE DRAWINGS

The foregoing and other features and advantages of the present invention will be more clearly understood from the following detailed description and the accompanying drawings, in which,

FIG. 1 is a perspective view of the invention;

FIG. 2 is an exploded perspective view of the invention;

FIG. 3 is an assembled sectional view of the invention;

FIG. 4 is another assembled sectional view of the invention,

FIG. 5 is a sectional view of the invention in a permanent braking state; and

FIG. 6 is a sectional view of the invention in a temporary braking state.

### DETAILED DESCRIPTION OF THE PREFERRED EMBODIMENT

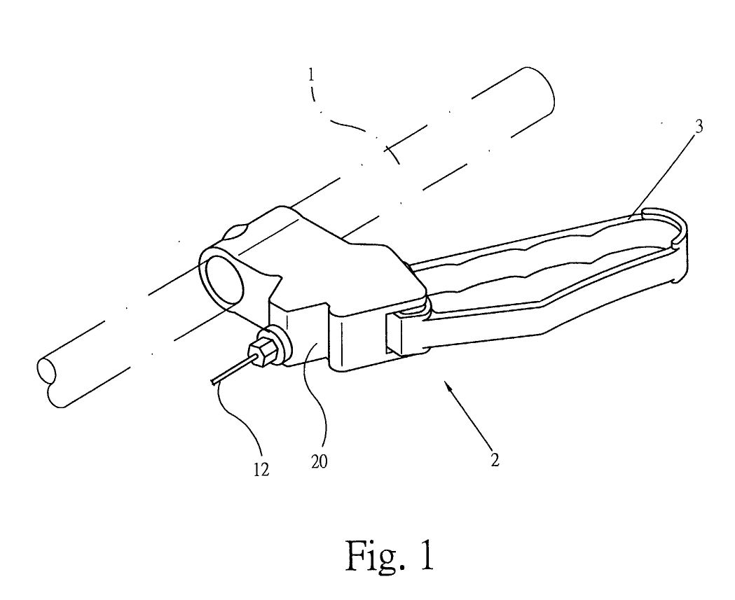

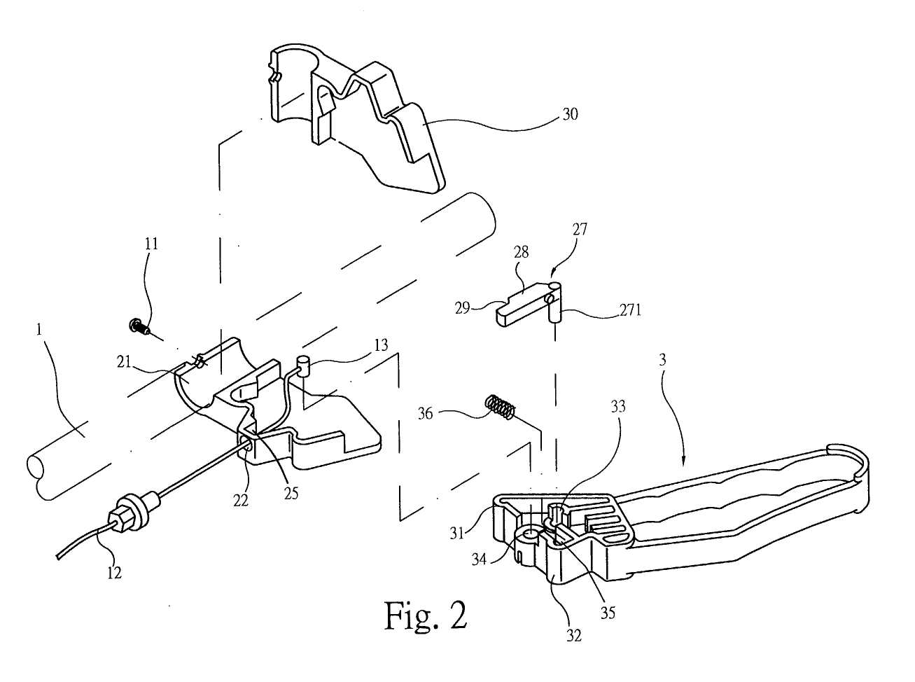

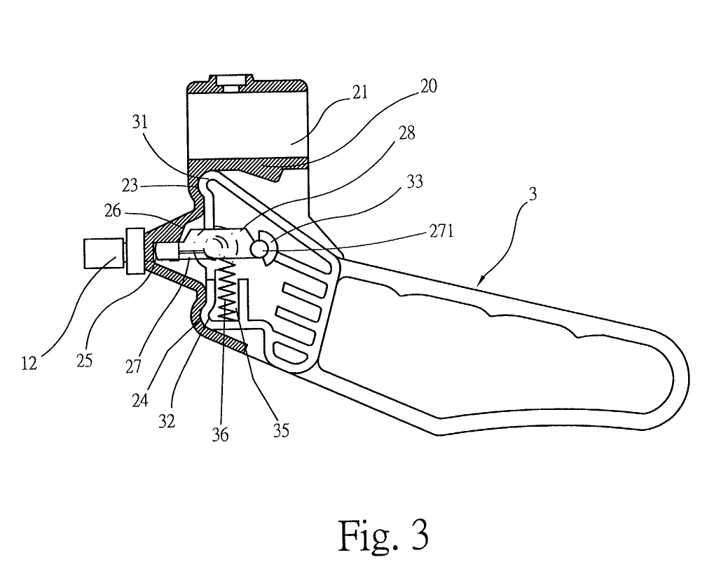

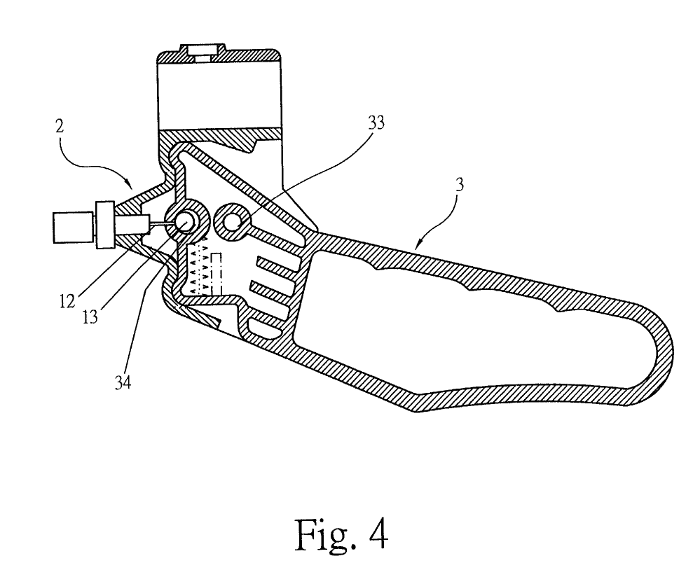

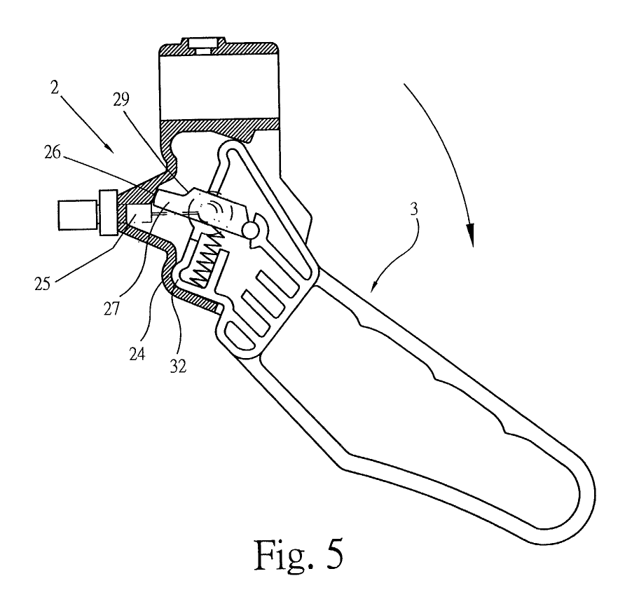

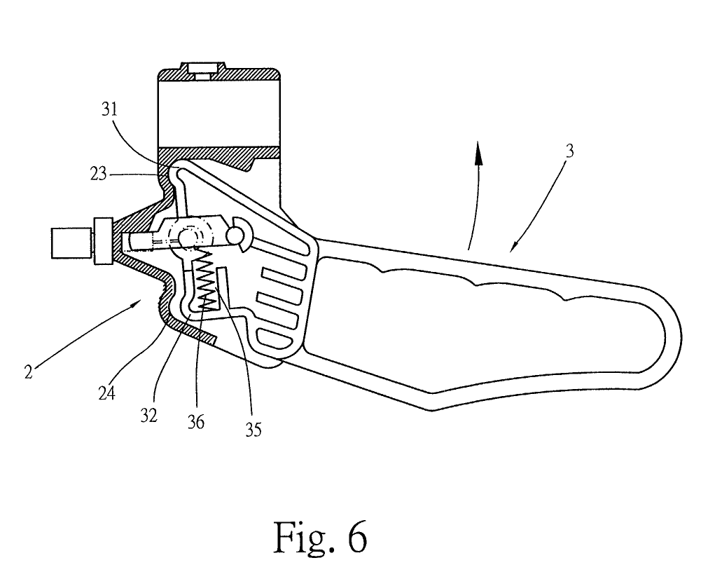

As shown in FIGS. 1 to 6, in an improved brake handle structure for mobility aids of the invention, a control handle 2 is connected to a handlebar 1 of a vehicle body. The control handle 2 has a main body 20. The upper section of the main body 20 has a transverse through bar hole 21. The handlebar 1 extends through the bar hole 21 and then secured, and is generally locked by means of a screw 11. The lateral side of the main body 20 is provided with a brake pull wire hole 22 for extension of a brake wire 12 therethrough, with a plug 13 inserted into a securing groove 34 in a rotary pull lever 3. The invention is characterized in that: the main body 20 is provided with a pair of cavities 23, 24 that are opposite to each other in upper and lower positions for insertion of upper and lower corners 31, 32 of an inner end of the pull lever 3. A press rod cavity 25 is disposed above the pull wire hole 22 of the main body 20 for insertion of an outer end of a press rod 27. A rotary shaft 271 at the inner end of the press rod 27 is connected pivotally in a rod sleeve 33 of the pull lever 3. A projecting portion 28 is provided near one side of the outer end of the press rod 27. A notch portion 29 is provided between the projecting portion 28 and the outer end of the press rod 27. Relative to the main body 20 is an inwardly projecting securing portion 26. When the pull lever 3 is pulled outwardly, i.e. pulled in a direction away from the handlebar 1, to rotate about a large angle, the outer end of the press rod 27 moves beyond the press rod cavity 25 to the securing portion 26 to be in the state shown in FIG. 5 so that the outer section of the press rod 27 is retained on the surface of the securing portion 26, which is permanent braking. At this time, the lower corner 32 rotates in the lower cavity 24, i.e. using the cavity 24 as rotational center. When the pull lever 3 is pulled inwardly, i.e. pulled in the direction toward the handlebar 1, as shown in FIG. 6, this is temporary braking. At this time, the upper corner 31 rotates in the upper cavity 23, with the cavity 23 as rotational center. The press rod 27 at the opposite side of the projecting portion 28 is connected to a spring seat 35 of the pull lever 3 and may be connected to a spring 36. The spring 36 is used to abut against the press rod 27 so as to stabilize the permanent braking. The outer cover of the main body 2 is provided with an upper cover 30. The other side of the pull lever 3 is an elongate U-shaped grip lever, the inner end having three projecting ribs to facilitate gripping. The outer end of the other side has a retracted portion.

In the structure as described above, the invention employs the retaining structure of the press rod to achieve two braking actions. The corner ends of the inner end of the handle constitute pivotal axis for rotation. Such a manner of rotation is different from the prior art that uses a screw bolt for locking purposes and as a rotational axis. The invention utilizes the handle itself as the axis of rotation, and uses only one press rod to cooperate with the projecting portions on the specially designed main body to thereby facilitate assembly and use. Besides, it is only necessary to add one or two parts. Compared with other forms, this invention provides a simple operational form. The combination of the form is very simple yet the operation is clear, providing users with great facility.

Although the present invention has been illustrated and described with reference to the preferred embodiment thereof, it should be understood that it is in no way limited to the details of such embodiment but is capable of numerous modifications within the scope of the appended claims.

What is claimed is:

1. In an improved brake handle structure for a mobility aid, a control handle is connected to a handlebar of a vehicle body, said control handle having a main body, an upper section of said main body having a transverse through bar hole, said handlebar extending through said bar hole and then secured, a lateral side of said main body being provided with a brake pull wire hole for extension of a brake wire therethrough, with a plug inserted into a securing groove in a rotary pull lever, characterized in that: said main body is provided with a pair of cavities that are opposite to each other in upper and lower positions for insertion of upper and lower corners of an inner end of said pull lever, a press rod cavity being disposed above said pull wire hole of said main body for insertion of an outer end of a press rod, an inner end of said press rod being connected pivotally in a rod sleeve of said pull lever, a projecting portion being provided near one side of the outer end of said press rod, a notch portion being provided between said projecting portion and the outer end of said press rod, relative to said main body being an inwardly projecting securing portion, such that when said pull lever is pulled in a direction away from said handlebar to rotate about a large angle, the outer end of said press rod moves beyond said press rod cavity to said securing portion to be retained thereby so as to be in a permanent braking state, and when said pull lever is pulled in the direction toward said handlebar, a temporary braking state is achieved.

2. The improved brake handle structure for a mobility aid as claimed in claim 1, wherein said press rod and said pull lever are connected to a spring.

3. The improved brake handle structure for a mobility aid as claimed in claim 2, wherein said pull lever has a spring seat disposed thereon.
